(19) United States
(12) Patent Application Publication
(10) Pub. No.: US 2009/0191301 A1
(43) Pub. Date: Jul. 30, 2009

(54) Flexible Plate Slot for a Hot Runner Injection Molding System

(75) Inventor: Martin Baumann, Burlington, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd., Bolton (CA)

(21) Appl. No.: 12/022,226

(22) Filed: Jan. 30, 2008

(51) Int. Cl. B29C 45/72

(52) U.S. Cl. 425/549

(57) ABSTRACT

A flexible plate system for a hot runner assembly includes a backing plate; a manifold plate detachably connected to the backing plate; a manifold positioned between the backing plate and the manifold plate and having at least one nozzle associated therewith; and wherein the manifold plate has at least one plate slot that allows the nozzle to extend through the manifold plate and having at least a first lateral dimension substantially larger than the outside diameter of the nozzle.

### CROSS REFERENCES

None.

### TECHNICAL FIELD OF THE INVENTION

The present invention relates generally to the field of injection molding equipment and, more particularly, to an improved hot runner mounting system.

### BACKGROUND OF THE INVENTION

Hot runner manifold systems are utilized to transfer molten material, typically plastic resin, from an injection molding machine to a mold. Hot runner manifold systems typically include a manifold plate, a manifold housed in the manifold plate, and a backing plate that supports the manifold and manifold plate. The manifold system routes molten material from a central sprue, which connects to an injection unit on an injection molding machine, to a plurality of nozzles which inject the molten material into cavities in the mold. The manifold system divides the flow of the molten material into several branches as it flows from the central sprue to the nozzles.

Referring to FIGS. 1 and 2, a prior art manifold system using two plates is shown with portions of the plates and main manifold cut away to reveal internal detail. A manifold assembly 10 is located between a manifold plate 12 and a backing plate 14. Sprue 16 connects to the manifold 10 at a central location. Manifold 10 has one or more melt channels 18 that communicate the molten material from the manifold 10 to nozzles (not shown) connected to the manifold 10.

One limitation of these prior art systems is that the backing plate 14 and manifold plate 12, in addition to the manifold 10, must be replaced each time a new hot runner system is desired. While the need for new manifolds and nozzles is largely unavoidable, the possibility of reusable plates represents a significant potential cost and time saving benefit. Even though the backing and manifold plates add relatively little value to a hot runner system relative to the manifolds and nozzles, these parts can represent as much as 30-40% of the cost of a new hot runner system

Therefore, it would be desirable to provide a hot runner plate system that is reusable with new or modified manifolds and nozzles.

The present invention is directed to meeting one or more of the above-stated desirable objectives.

### SUMMARY OF THE INVENTION

One aspect of the present invention is to provide a hot runner plate system that may be reused with new or modified manifold(s) and nozzles in a different configuration.

In accordance with the above aspects of the invention, there is provided a flexible plate system for a hot runner assembly that includes a backing plate; a manifold plate detachably connected to the backing plate; a mold manifold positioned between the backing plate and the manifold plate and having at least one nozzle associated therewith; and wherein the manifold plate has at least one plate slot that allows the nozzle to extend through the manifold plate and having at least a first lateral dimension substantially larger than the outside diameter of the nozzle.

In an another embodiment, the manifold plate has a plurality of dowel holes located along the perimeter of the plate slot to accommodate dowels for positive location of the nozzle relative to the plate slot.

These aspects are merely illustrative of the various aspects associated with the present invention and should not be deemed as limiting in any manner. These and other objects, aspects, features and advantages of the present invention will become apparent from the following detailed description when taken in conjunction with the referenced drawings.

### BRIEF DESCRIPTION OF THE DRAWINGS

Reference is now made to the drawings which illustrate the best known mode of carrying out the invention and wherein the same reference numerals indicate the same or similar parts throughout the several views.

FIG. 1 is a plan view of a prior art hot runner system showing the manifold plate and nozzles extending therethrough.

FIG. 2 is a cross sectional view of the prior art hot runner system shown in FIG. 1.

FIG. 3 is a plan view of a hot runner system according to one embodiment of the present invention showing the manifold plate and nozzles extending therethrough.

FIG. 4 is a cross-sectional view of the hot runner system of FIG. 3.

FIG. 5 is a top view of a manifold plate according to an embodiment of the present invention.

FIG. 6 is a cross sectional view of a hot runner system according to an alternate embodiment of the present invention.

FIG. 7 is a bottom view of a manifold plate according to another embodiment of the present invention.

FIG. 8 is a bottom view of a manifold plate according to another embodiment of the present invention.

FIG. 9 is a cross sectional view of a system according to another embodiment of the present invention.

FIG. 10 is a cross sectional view of a system according to yet another embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. For example, well-known methods, procedures, and components have not been described in detail so as not to obscure the present invention.

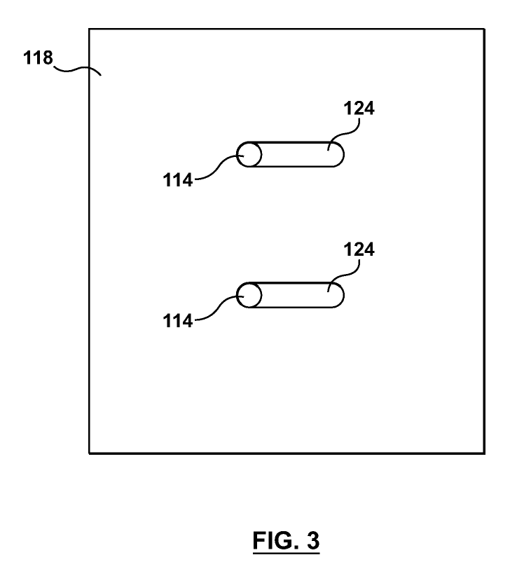

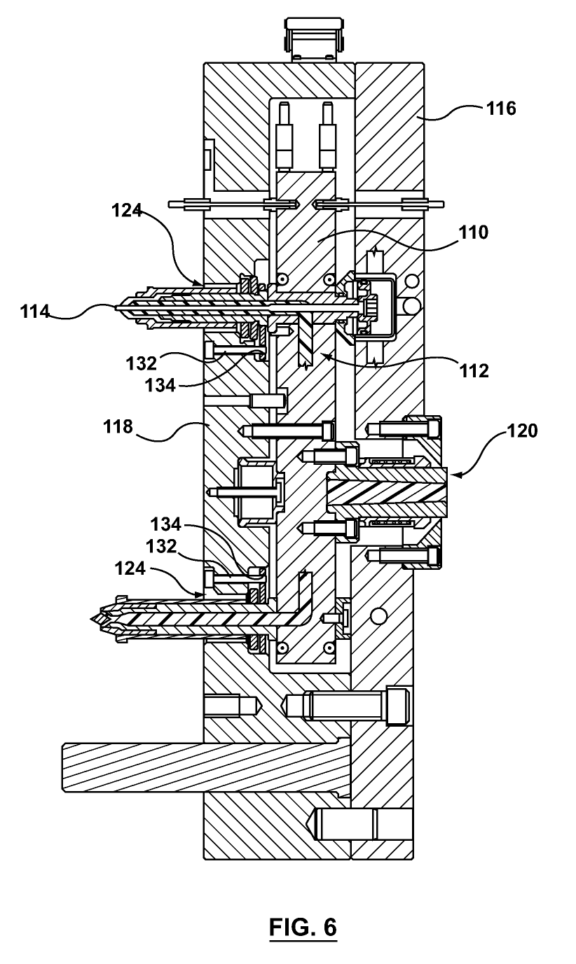

FIGS. 3-8 illustrate the overall arrangement of a first embodiment of an improved hot runner injection molding system. The device includes a mold manifold 110, having manifold melt channel 112 through which molten material reaches injection nozzles 114. The mold manifold 110 is surrounded and supported by a backing plate 116 and a manifold plate 118. The mold manifold 110 is, in effect, “sandwiched” between the backing plate 116 and manifold plate 118.

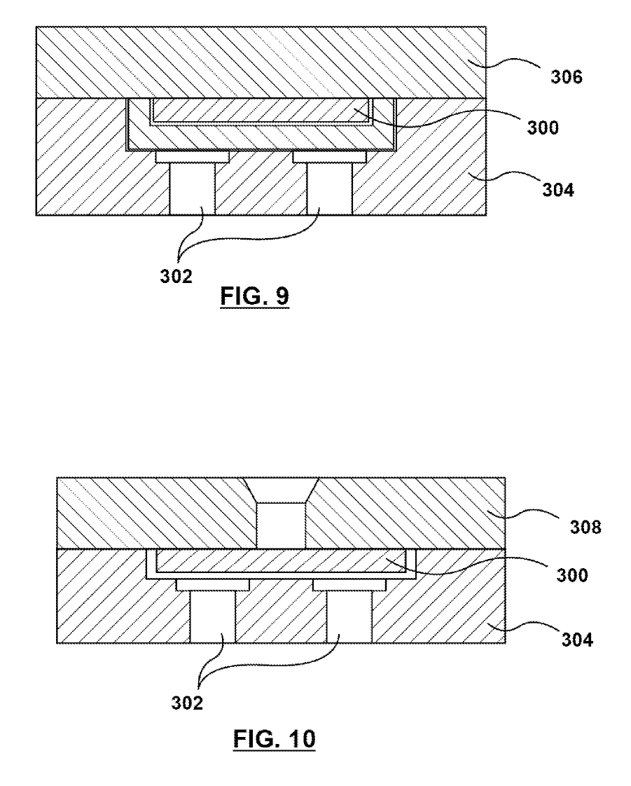

While FIGS. 3-8 illustrate one embodiment, in some cases either the manifold plate 118 or the backing plate 116 may be considered to be part of the mold assembly rather than the hot runner assembly. A shown in FIG. 9, the manifold 300 and nozzles 302 may be located in a hot runner manifold plate 304 that is either inserted or mounted to the mold plates (not shown) with the backing plate 306 taking the form of a mold plate (considered as part of the mold rather the hot runner). In another embodiment, illustrated in FIG. 10, the backing plate is eliminated and a machine platen 308 is used to contain the hot runner system. Those of skill in the art will appreciate that the present invention is equally suitable for use with any of these different structural arrangements.

The central sprue 120 delivers melt to the mold manifold 110. Melt then passes through a series of melt channels 112 within the mold manifold 110 to the injection nozzles 114, where it is delivered to each gate of the mold (not shown).

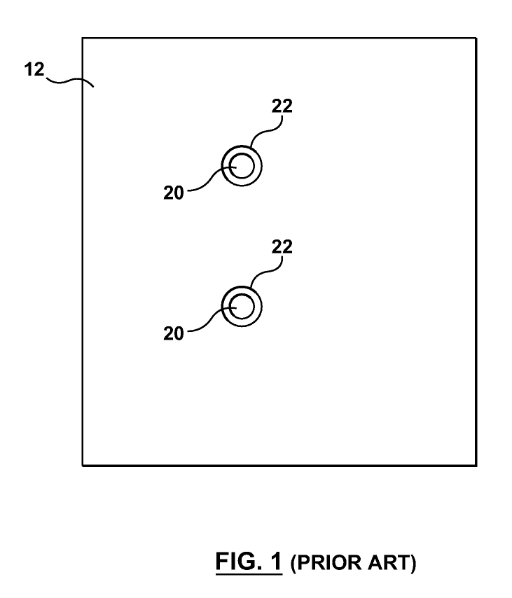

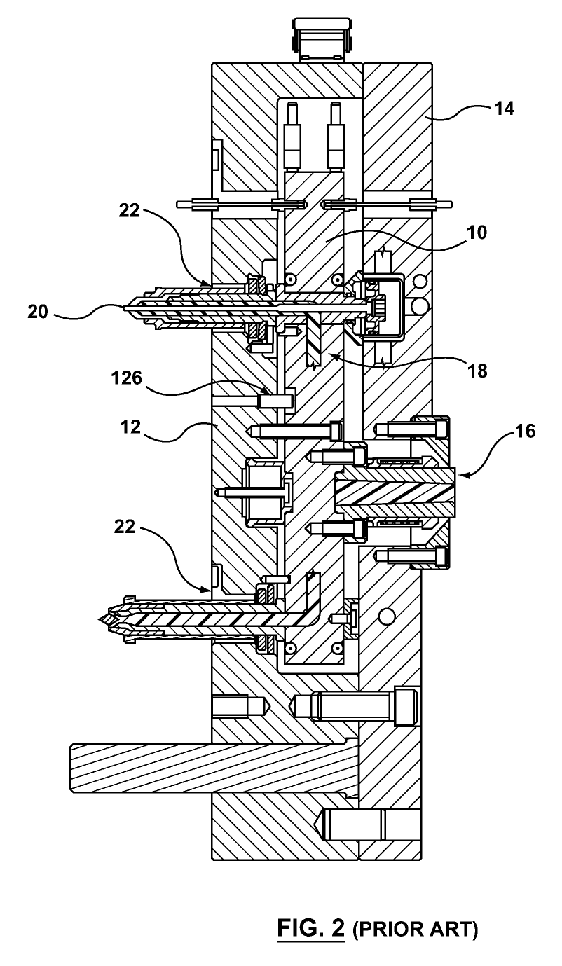

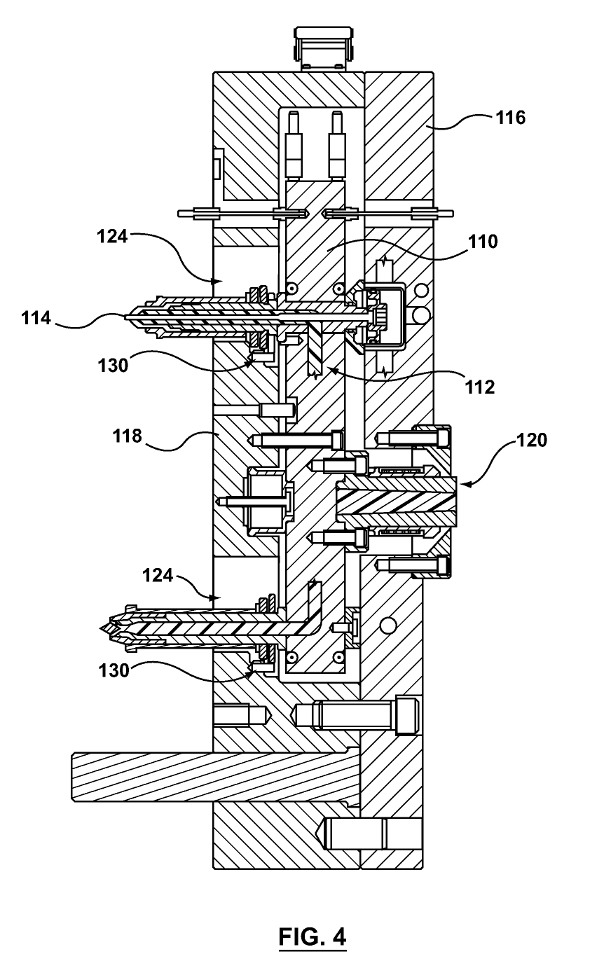

As can be seen most clearly in FIG. 4, each injection nozzle 114 protrudes through and extends out of the manifold plate 118. In prior art hot runner systems, as shown in FIGS. 1 and 2, a plate bore 22 is provided in the manifold plate 16 to accommodate each nozzle 22. These plate bores 22 are sized to match, with some clearance, the outside diameter of the nozzles 22. In the improved system disclosed herein, the manifold plate 118 is provided with plate slots 124. In one embodiment, these plate slots 124 are provided with a first lateral dimension—the width—that matches, again, with some clearance, the outside diameter of the nozzles 114. However, the plate slots 124 are provided with a second lateral dimension—the length—significantly longer than the diameter of the nozzles 114 such that the nozzles may be positioned in multiple locations along that slot length, thus providing the desired positioning flexibility. The length of the plate slots 124 may utilize any number of dimensions and is limited only by the nozzle configuration used in the hot runner system and thermal considerations.

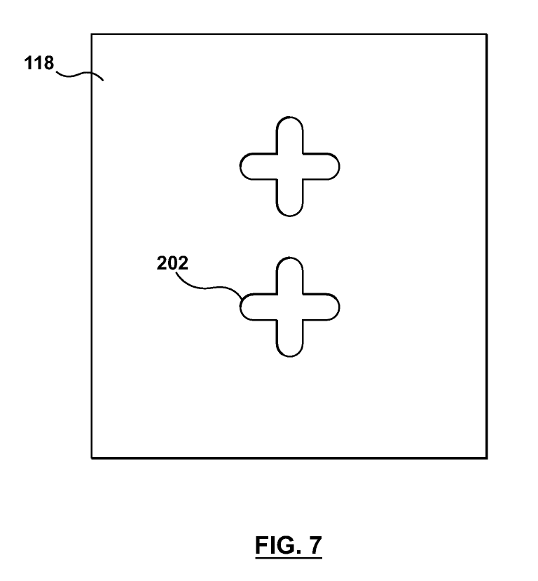

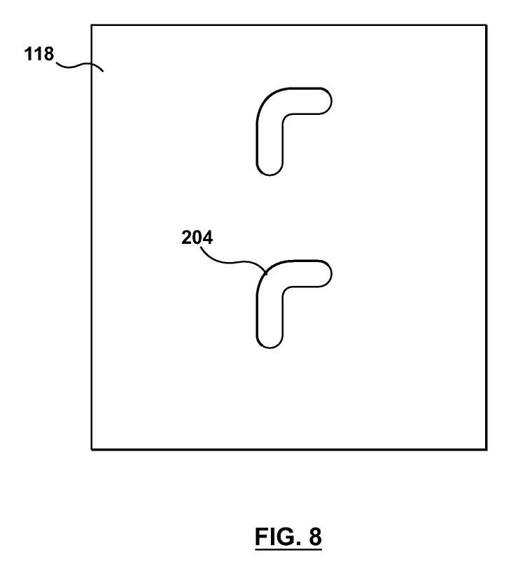

While an elongated slot has been previously described, it is contemplated as being within the scope of the present invention to use expanded openings in a variety of configurations. FIGS. 7 and 8 illustrate a number of non-limiting examples including multi-leg slots 202, and L-shaped slots 204. Thus, the term “plate slots” is intended to be non-limiting as to the shape of the enlarged opening contemplated by the present invention. The rounded ends or corners of such shapes obviously being intended to accommodate the rounded diameter of the nozzles.

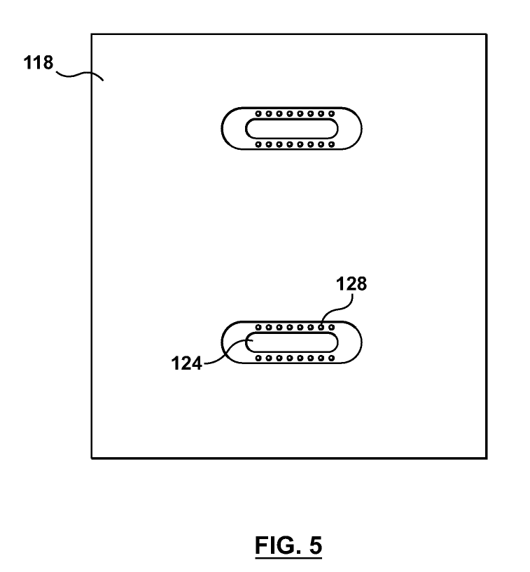

It is typical in hot runner systems for dowels 126 to be used to position the mold manifold 110, and consequently the nozzles 114, relative to the manifold plate 118. These dowels 126 are frequently positioned between nozzles such that they do not directly relate to the plate bores or in the case of the present invention, plate slots. However, in an alternate embodiment of the present invention illustrated in FIG. 5, an additional multi-position positive locating mechanism may be incorporated in the plate slots 124 previously described. In one version of this embodiment, a plurality of dowel holes 128 are provided along the perimeter of the plate slots 124 to accommodate additional dowels 130 associated with each individual injection nozzle 114. The plurality of dowel holes 128 allow positive locating of the nozzles 114 relative to the plate slots in the multiple positions within the plate slots 124.

In another version of this embodiment, screws 132 are utilized as the positioning device rather than dowels. In this version, screw through holes 134 are positioned along the perimeter of the plate slots 124, and the screws 132 are inserted into those holes 134 from the outside of the manifold plate 118 and into a threaded hole (not shown) associated with each nozzle 114.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

We claim:

1. A flexible plate system for a hot runner assembly, comprising:
a manifold plate;
a mold manifold positioned adjacent said manifold plate and having at least one nozzle associated therewith, said nozzle having an outside diameter; and
wherein said manifold plate defines at least one plate slot therein, said plate slot allowing said nozzle to extend through said manifold plate and having at least a first lateral dimension substantially larger than said outside diameter of said nozzle.

2. The flexible plate system for a hot runner assembly as set forth in claim 1, wherein said plate slot has at least a second lateral dimension substantially larger than said outside diameter of said nozzle.

3. The flexible plate system for a hot runner assembly as set forth in claim 1, wherein said plate slot comprises an elongated slot shape.

4. The flexible plate system for a hot runner assembly as set forth in claim 1, wherein said plate slot comprises a multi-leg elongated slot.

5. The flexible plate system for a hot runner assembly as set forth in claim 1, wherein said plate slot comprises an L-shaped elongated slot.

6. The flexible plate system for a hot runner assembly as set forth in claim 1, further comprising a multi-position positive locating mechanism associated with a perimeter of said plate slot.

7. The flexible plate system for a hot runner assembly as set forth in claim 1, wherein said manifold plate further defines a plurality of dowel holes along at least a portion of a perimeter of said plate slot to accommodate dowels for positive location of said nozzle relative to said plate slot.

8. The flexible plate system for a hot runner assembly as set forth in claim 1, wherein said manifold plate further defines a plurality of screw through holes along at least a portion of a perimeter of said plate slot to accommodate screws for positive location of said nozzle relative to said plate slot.

9. A flexible plate system for a hot runner assembly, comprising:
a backing plate;
a manifold plate detachably connected to said backing plate;
a mold manifold positioned between said backing plate and said manifold plate and having at least one nozzle associated therewith, said nozzle having an outside diameter; and
wherein said manifold plate defines at least one plate slot therein, said plate slot allowing said nozzle to extend through said manifold plate and having a shape selected from the group consisting of an elongated slot, a multi-leg slot, and an L-shaped slot.

10. The flexible plate system for a hot runner assembly as set forth in claim 9, wherein said manifold plate further defines a plurality of dowel holes along a perimeter of said plate slot to accommodate dowels for positive location of said nozzle relative to said plate slot.

11. The flexible plate system for a hot runner assembly as set forth in claim 9, wherein said manifold plate further defines a plurality of screw through holes along a perimeter of said plate slot to accommodate screws for positive location of said nozzle relative to said plate slot.

12. A flexible plate system for a hot runner assembly, comprising:
a backing plate;
a manifold plate detachably connected to said backing plate; and
wherein said manifold plate defines at least one plate slot therein, said plate slot having a shape selected from the group consisting of an elongated slot, a multi-leg slot, and an L-shaped slot.

13. The flexible plate system for a hot runner assembly as set forth in claim 12, wherein said manifold plate further defines a plurality of dowel holes along a perimeter of said plate slot.

14. The flexible plate system for a hot runner assembly as set forth in claim 12, wherein said manifold plate further defines a plurality of screw through holes along a perimeter of said plate slot.
